(19) United States
(12) Patent Application Publication
(10) Pub. No.: US 2007/0274818 A1
(43) Pub. Date: Nov. 29, 2007

(54) METHOD AND DEVICE FOR EXTENDING AND RETRACTING A REACH

(76) Inventor: Glynn Beverley Burke, Paradise (CA)

Correspondence Address: GLYNN B. BURKE, P.O. BOX 5653, ST. JOHN'S, NF, A1C-5W8, CA

(21) Appl. No.: 11/746,331

(22) Filed: May 9, 2007

Related U.S. Application Data
(60) Provisional application No. 60/746,780, filed on May 9, 2006.

(51) Int. Cl. B65G 1/133

(52) U.S. Cl. 414/749.1

(57) ABSTRACT

A reach is formed by the creation of a protective corridor or conduit which itself becomes the instrument of reach. Extension of a reach is achieved by advancing material required to extend the reach through the protective corridor to the leading edge where it becomes incorporated into the outer protective corridor in a manner that extends the protective corridor and hence causing an extension of the reach. In a reverse process retraction of the reach is achieved. Direction control for a reach is achieved by providing operator control over the corridor extension process. Alternately direction control can be determined by the immediate environment or a combination of operator control and immediate environment. Direction control during retraction of a reach is inherent in the reaching method as the outer protective corridor is retracted back into itself at the leading edge thereby retracting the reach along the reverse course of prior extension.

### CROSS-REFERENCE TO RELATED APPLICATION

This patent application claims priority to the U.S. provisional Patent Application No. 60/746,780 filed May 9, 2006 and incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

A common method to perform a reaching action with a machine is to use a robotic arm made up of segments and joints so that the arm can bend and rotate to create a reaching action. For machines that perform repetitive reaching actions such as pick and place, they are typically computer controlled and programmed for a specific task. Nondeterministic or random reaching actions typically require some form of operator control.

There are numerous examples of operator controlled reaching devices. The medical industry is advancing towards robotic surgery whereby a doctor can operates controls to manipulate a device that performs a reaching motion in order to accurately position instrumentation. Once positioned the doctor manipulates the instrumentation to perform the desired operation. Working on the same reaching principle, the operator on an excavator operates controls to manipulate the excavator's arm such that it performs a reaching action in order to position work devices at the end of the arm.

The reaching action that a machine can perform is determined by the method it embodies to perform the reach. For instance in a reaching method that is characterized by a robotic arm comprised of segments with joints capable of bending and rotating, the range and path of reach that can be performed is determined by the set of positioning arrangements that can be formed with the sequence of segments and joints. In addition the ability to extend or retract any reach is dependent on unobstructed space as required for the necessary arrangement of segments and joints to take position.

The reaching method described so far has been suitable for performing the tasks they were designed for. However methods have been sought after to extend the range and path of a reach and furthermore limit the need for unobstructed space necessary for performing a reach. Ranges have been extended by the use of telescopic arms or devices capable of travel. Companies and institutions are addressing the issue of the path of a reach and performing a reach in obstructed spaces by using snake like devices. A variation on the snake method is one of simulating the action of an elephant's trunk. Research in this area is also being conducted by a number of institutions. The text prelude to many of the research efforts in snake and elephant trunk like devices underscore the need for a device capable of reaching into difficult environments such as the rubble of a collapsed building.

The reaching method as provided for by the disclosures herein presented was inspired by the need to perform a reach through obstructed environments, however the method itself has numerous applications.

### SUMMARY OF THE INVENTION

The embodiment of the herein disclosed reaching method by a device or machine enables the device or machine to perform a reach and carry out related functions such as but not limited to inspection, delivery, retrieval and operating on and/or interaction with the target of a reach.

The reaching method is one of creating a reach by forming a protective service corridor along the path of the reach. The reach itself is extended by supplying the materials needed to extend the reach through the protective service corridor that is being established as a reaching machine advances its reach. When the material has advanced through the protective service corridor to the leading edge, it exits and assumes a position such that it creates an extension of the protected service corridor, thereby extending the protective service corridor and inherently extending the reach being established by the protective service corridor.

A device that embodies the reaching method can function such that the reach is permanent or retractable. When retractable, the process of retreat is one whereby the protective service corridor is drawn back into the corridor itself and hence shortening the length of reach. When retreating, retracted material moves through the protective service corridor towards the original starting point, exiting from there.

If required, the machine that embodies the reaching method is capable of holding an instrument head at a position relative to the leading edge of the service corridor. The holding function can be achieved by various means that are applicable to different embodiments of the reaching method. If the material being moved forward is to be used in an extrusion process that advances the service corridor, then a part of the instrument head will serve the extrusion process and be secured to that portion of the service corridor that has already been extruded.

If the material is being moved through the service corridor such that it can unfurl out to extend the corridor or be drawn back in to shorten the corridor, then a holding position can be created by unfurling material around a torus shaped component at the leading edge and then embracing both the torus component and material that flows around it such that the material flows between the embrace and the torus component while the embrace itself causes the embracing instrument to maintain a position relative to the leading edge. In a manner somewhat analogous to this a holding force can be formed inside the service corridor using bearings or rollers that maintain their position relative to the leading edge and are able to embrace a third component to which the instrument head is attached and therefore able to advance or retreat with the leading edge of the protective service corridor. With this configuration the instrument head could be recessed back from the leading edge. A recessed instrument head, by it's own means could still protrude forward to a position ahead of the leading edge when required.

Instruments heads are designed for the purpose of the reach. That which is tethered to the instrument head (cables etc) advances or is drawn through the protective service corridor as the reach is extended. In addition the service corridor provides for delivery and retrieval of payloads through the reaching device.

The machine is constructed such that the direction of advance can be remotely controlled. Intentional direction is achieved by controlling the corridor extension process and optionally via actuation points established along the corridor or located at the instrument head. Alternately direction control can be relaxed or turned off so that the direction of advance is determined by the immediate environment through which the reaching machine is extending its reach. Therefore it can follow the path of least resistance or a combination of such path and user controlled direction.

Advancing a reach involves moving the required material to extend the protective service corridor through already established corridor to the leading edge of the service corridor. Said material as required to advance a reach can be moved inside the service corridor by a drive mechanism such as motors and drive wheels located at the instrument head and/or points along the service corridor as may be required. Additionally said material can be moved inside the service corridor by other means such as introducing a pressure differential that has an effect at the leading edge of the service corridor or by causing a peristaltic wave to propagate along the service corridor in such a manner that it is able to interact with and cause the said material to move within the service corridor.

This material will depend on the purpose and specific task and machine that embodies the reaching process. A machine reaching into a mine shaft will be constructed of different materials and dimensions than a reaching machine for the medical industry.

The structure of the corridor being created will vary depending on the intended application of a reaching machine. In the application of a reaching device designed to travel several miles into a mine shaft for inspection or aid in a rescue, or along terrain to aid for example in fire fighting, the cross sectional dimension of the protective corridor being created may be one or two feet or more if needed. The structure could incorporate parts, such as rods and rollers that assist in providing a means for additional material to flow easily through the service corridor to the leading edge.

In the case of a medical application the reaching machine might extend a reach using highly flexible tubular material with a cross sectional dimension measured in millimeters.

In sample embodiments discussed to this point, the reaching devices are bound at one end to the starting point and can extend their reach to a distance determined primarily by the available material supply. In an alternate embodiment of the process, corridor material normally secured to the starting point can then be attached to the end of the material supply. It can be drawn into the protective service corridor, move towards and exit the opposite end. Thereby creating a device that moves by embodying the reaching method described here but is not bound at one end.

### BRIEF DESCRIPTION OF THE DRAWINGS

An embodiment of the reaching method is illustrated in the figures of the accompanying drawings which are meant to be exemplary and not limiting, in which like references are intended to refer to like or corresponding parts, and in which:

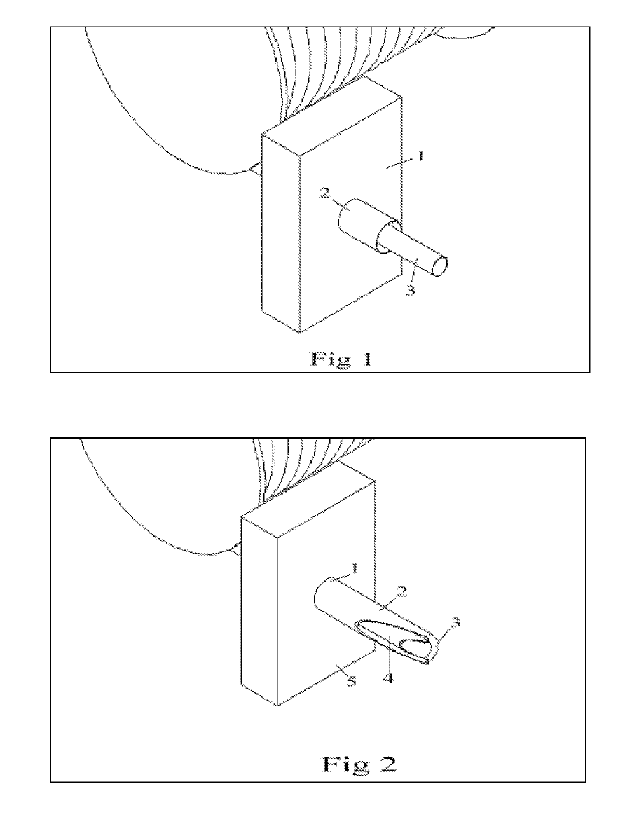

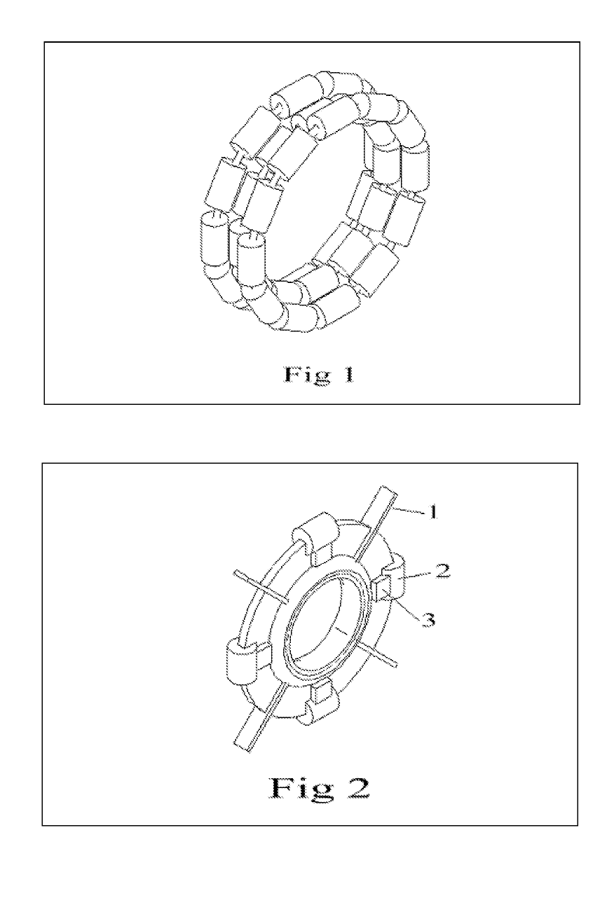

Drawing 1, FIG. 1 illustrates the starting component for establishing a reach by a reaching device.

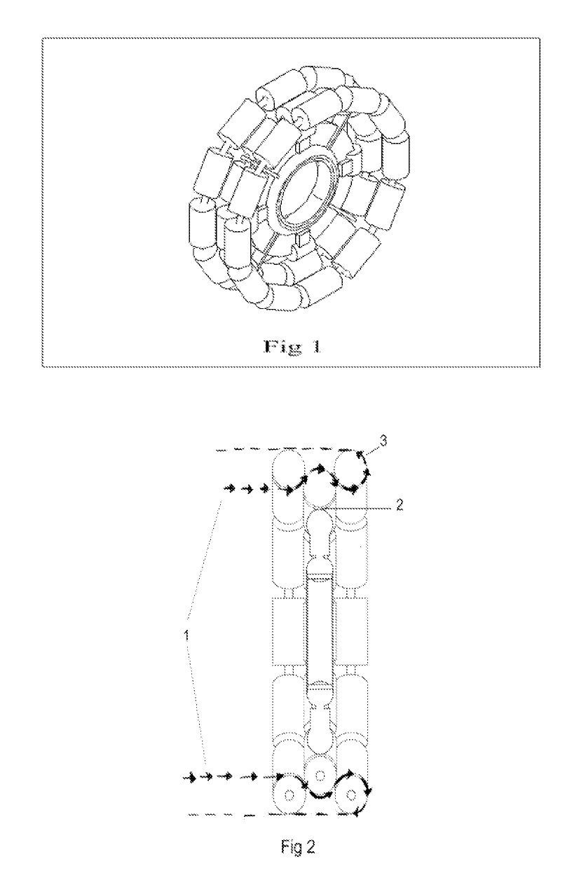

Drawing 1, FIG. 2 illustrates the formation of a protected service corridor that becomes the instrument of reach.

Drawing 2, FIGS. 1 and 2 and Drawing 3, FIG. 1 and 2 illustrate a method and device to cause a mounting platform to advance and retreat with the leading edge of the reaching device and a means to apply drive and direction control to the reaching device.

### DETAILED DESCRIPTION

A device that embodies the reaching method uses a material supply to create a protective service corridor that becomes the instrument of reach. The preferred embodiment operates on a tubular supply of material but may form that tubular shape itself from one or more material sources.

Drawing 1, FIG. 1 illustrates the starting component for establishing a reach by a reaching device. A starting component 1 has an exit hole with an exit sleeve 2. The tubular structured material 3 is first passed through said exit sleeve 2.

Drawing 1, FIG. 2 illustrates the formation of a protected service corridor that becomes the instrument of reach. The properties of the material are such that the tubular structure can expand to be folded back over itself. After passing through said exit sleeve the tubular structure 4 is expanded in diameter and folded back over itself and secured to the outer surface of said exit sleeve at indicated position 1. By folding the tubular structure back over itself and securing it to the exit sleeve, the supply of tubular material has been used to create it's own protective service corridor 2 through which additional tubular material can advance forward to unfurl and further extend the protective service corridor at the leading edge of the protective service corridor 3.

An appropriate force applied to the tubular material supply causing it to enter the starting component 5 will result in a transfer of force through the material supply 4 inside the protective service corridor to that portion of the material that makes up the leading edge 3 of the protective service corridor. The force will cause material at and immediately inside the leading edge to unfurl out and assume a position in the formation of an extension of the protective service corridor. Such a force will cause the corridor to extend along the path of least resistance. Such extension will occur up to such a point wherein internal resistance in the service corridor against movement of the material supply exceeds the force being applied to move the material.

A tubular material supply passing through the exit sleeve of a starting component and folded back over itself and secured to the exit sleeve, and the ability of an operator to grasp said material in order to apply a force to move said material supply into and out of the exit sleeve represents a basic device that embodies the reaching method. Such a device would be suitable for reaching requirements where the path of reach is governed by deflection forces such as what would be encountered when extending a reach through a pipe or conduit.

Although the leading edge is extending, there is no movement of surface between the outside surface of the protective corridor and that which the surface comes in contact with. Only static contact should exist between these surfaces. All material movement required to extend the leading edge happens inside the protective service corridor which is a controlled environment designed for the movement of the tubular material and thus the advancement or retreat of the tubular material.

The service corridor also provides a channel whereby cables or other tubing might be inserted and caused to move towards the leading edge. Retreat of the leading edge is achieved by applying a force to the tubular material supply to cause the material supply to move back towards the starting component. This force is transferred through the tubular material to the leading edge whereby it causes the leading edge to be drawn back into the corridor resulting in a shortening of the corridor.

Making a Device that Embodies Drive and Direction Control

As in the previous embodiment, a tubular material supply is first passed through an exit sleeve. The material is then caused to weave around a series of three bearing rings where each bearing ring has the form of a torus (Drawing 2, FIG. 1).

Drawing 2, FIG. 2 illustrates a drive component containing drive motors 3 and drive wheels 2. Said drive component has mounting brackets 1 for attachment to the center bearing ring. Drawing 3, FIG. 1 illustrates the drive component attached to the center bearing ring.

Drawing 3, FIG. 2 illustrates is a cross section of the drive component with a series of arrows 1 that show the weave path taken by material as it passes through the drive component. A drive wheel has a point of contact 2 where it engages the bearing ring. Each of the four drive wheels engages the center bearing ring at four equally spaced points around the center bearing ring. Power applied to a drive wheel will cause the bearing that it has contact with to turn. The tubular material supply that is in contact with that bearing will be moved accordingly. Applying equal turning force to all four motors to advance the tubular material supply will cause the corridor extension to happen in a forward direction. As said material exits the weave it performs an unfurling action that extends the protective service corridor as it is wrapped back 180 degrees around the outside circumference of the forward bearing ring 3.

Applying unequal turning force to opposite drive wheels will tend to cause one side of the tubular material to move faster or slower than the opposite side. The material supply must be of such make up that it can respond to this differential in forces by allowing one side of the material to compress and move slower and/or allowing one side to extend to advance faster. The result of this differential of forces applied to opposite sides of the tubular structure of the material supply as it unfurls out of the service corridor is such that the direction of extension of the protective service corridor is altered during the unfurling and corridor extension process, and hence providing for direction control.

The drive component illustrated in Drawing 2, FIG. 2 serves as a mounting platform for instrumentation that is to follow along with the leading edge of the extending service corridor.

To better facilitate the movement of tubular material through the service corridor over longer distances, a train of idler wheels is inserted around the material supply as it enters the starting component. The function of the idler wheels is to cause a separation between the outer surface of the tubular structure that is being moved through the service corridor and the inner surface of the service corridor itself.

At set intervals idler wheels can be replaced with powered drive wheels to facilitate the movement of the tubular material supply over extended distances.

What is claimed is:

1. A method and device to extend a reach whereby the extension of the reach creates a protective service corridor which facilitates further extension of the reach while becoming a service channel between the base point of the reach and the leading edge.

2. The method and device of claim 1, wherein material required to advance the leading edge of the reach passes through the protective service corridor towards the leading edge and unfurls out at the leading edge at which point that material no longer advances but assumes position in the ongoing formation of the protective service corridor, which inherently is the instrument of reach. Alternately to perform a retreat of the leading edge, material that has unfurled out at the leading edge and assumed position as part of the protective service corridor is drawn back into the corridor in reverse sequence and moved towards the base point of the reach such that the leading edge is caused to retreat.

3. The method and device of claim 1, wherein material required to advance the leading edge of the reach passes through the protective service corridor towards the leading edge and is used to advance the protective service corridor employing a process of construction and/or extrusion.

4. A method and device to apply controlled forces to cause material that will form an extension of the protective service corridor to flow through the protective service corridor towards the leading edge or retract back into the protective service corridor and flow in a reverse direction to exit at the base point.

5. The method and device of claim 4, wherein a pressure differential is used to cause material to be drawn into the protective service corridor and advance forward towards the leading edge. A pressure differential is achieved by the introduction of gas or liquid to the space that exists between the inside surface of the protective service corridor wall and the outside surface of the material supply that is to be advanced through the protective service corridor. The introduction of gas or liquid in this space will increase pressure and promote expansion of the space. Expansion of the space occurs at the leading edge of the protective service corridor as the increased pressure at this location causes the leading edge to unfurl out and assume position in the extending protective service corridor and in the same process additional material is drawn towards the leading edge. The strength of the service corridor wall must be sufficient to counter the increased pressure so that expansion of the space occurs at the leading edge.

6. The method and device of claim 4, wherein a series of drive motors are positioned along the length of the protective service corridor and interacting with the material inside the service corridor and causing it to pass through the service corridor as required to either advance or retreat the leading edge.

7. The method and device of claim 4, wherein a peristaltic wave is initiated along the length of the protective service corridor for the purpose of moving material through the corridor. The peristaltic wave is one of contraction and expansion in diameter of the protective service corridor and propagating along the length of the corridor and interacting with the material inside the service corridor and causing it to pass through the service corridor as required to either advance or retreat the leading edge.

8. The method and device of claim 4, wherein a peristaltic wave is initiated along the length of the protective service corridor for the purpose of moving material through the corridor. The peristaltic wave is magnetic in nature and operating such that a magnetic force propagates along the length of the corridor interacting with the material inside the service corridor and causing it to pass through the service corridor as required to either advance or retreat the leading edge.

9. A method and device to advance instrumentation with the leading edge by utilizing the leading edge itself or by causing and utilizing a standing wave to form in the material near the leading edge and at a consistent position relative to the leading edge. Components are held in place by their ability to embrace the leading edge and/or by interaction with and/or encapsulation by said standing wave such that instrumentation attached to said components can be held in a consistent position relative to the leading edge. Although held in position, the instrumentation may have range of maneuverability itself.

10. A method and device to control the direction of reach by controlling the rate of corridor extension at different points on the leading edge.

11. The method and device of claim 10, wherein extension of the protective corridor occurs by unfurling of material from within, and the rate of unfurling of material at different points on the leading edge is determined by the turning force applied to drive wheels that interact with unfurling material at the leading edge.

12. The method and device of claim 10, wherein extension of the protective corridor occurs by extrusion of material from within, and the instrument for extrusion is capable of varying the rate of extrusion at different points on the leading edge of the extruding corridor, hence causing the plane of the leading edge to change resulting in a change of direction for the subsequent extruded corridor.

13. The method and device for a derived embodiment of the reaching method whereby material that is folded back over itself to form the protective corridor and normally secured to the starting point of a reach is not attached to said point but instead folded back over exactly half of the material length such that it can be attached to the end of the material supply. Such a device can assume controlled movement by embodying the methods disclosed herein for moving material through it's own protective corridor. It will not form a continuous protected service corridor from a starting point to an end point. Instead the corridor is of fixed length with one end being retracted back into the corridor as material moves internally and exits the opposite end to extend the corridor at that end. It will move through an environment with only static contact between the outside surface of the device and the environment that it makes contact with.
